(19) United States
(12) Patent Application Publication
(10) Pub. No.: US 2024/0351249 A1
(43) Pub. Date: Oct. 24, 2024

(54) METHOD FOR OBTAINING RECYCLATE FROM THERMOSETTING MATERIALS, MANUFACTURING METHOD FOR A THERMOSETTING FIBER COMPOSITE SEMI-FINISHED PRODUCT AS WELL AS USE OF A RECYCLATE POWDER AS A FILLER FOR MANUFACTURING A THERMOSETTING FIBER COMPOSITE SEMI-FINISHED PRODUCT, MANUFACTURING A RECYCLATE POWDER AS AN ALTERNATIVE FILLER FOR MANUFACTURING PLASTIC PRODUCTS AND FURTHER SECTORS

(71) Applicant: POLYTEC PLASTICS Germany GmbH & Co. KG, Lohne (DE)

(72) Inventors: Julian ROCHA, Kraichtal-Gochsheim (DE); Sebastian NUBER, Kraichtal-Gochsheim (DE); Andreas WETZEL, Kraichtal-Gochsheim (DE)

(21) Appl. No.: 18/643,774

(22) Filed: Apr. 23, 2024

(30) Foreign Application Priority Data
Apr. 24, 2023 (DE) 10 2023 110 406.3

(51) Int. Cl. B29B 17/04; B29K 101/12; C08J 5/04

(52) U.S. Cl. CPC B29B 17/0404; C08J 5/043; C08J 5/046; B29K 2101/12; C08J 2300/24

(57) ABSTRACT

A method for obtaining recyclate from thermosetting materials, comprising the following method steps:
providing thermosetting starting materials to be recycled; breaking the thermosetting starting materials with a twin-shaft shredder to obtain a plurality of fragments; shredding the fragments with a single-shaft shredder to obtain a plurality of flakes; and fine grinding of the flakes with a grinding device to obtain a recyclate powder.

### CROSS REFERENCE TO RELATED APPLICATIONS

This application claims priority to German Patent Application No. DE 10 2023 110 406.3, filed Apr. 24, 2023, incorporated herein by reference.

The invention relates to a method for obtaining recyclate from thermosetting materials, such as in particular from thermosetting fiber composite components to be recycled, and to a manufacturing process for a thermosetting fiber composite semi-finished product as well as to the use of a recyclate powder obtained from thermosetting materials, such as, in particular, from thermosetting fiber composite components to be recycled, as a filler for manufacturing a thermosetting fiber composite semi-finished product or as an alternative filler for the plastics industry and in further sectors.

Devices and methods for obtaining fillers from recycled components or from reused thermosets or thermosetting fiber composite components are already known from prior art. A disadvantage of methods and devices from prior art is that they cannot produce a uniform and therefore homogeneous recyclate with an average particle diameter in the range of less than 100 μm, which leads to failures in the manufacturing process in the practical application of the recyclate in manufacturing thermosetting plastics, such as in particular in manufacturing thermosetting fiber composites. These failures can be film tears due to sharp-edged particles in the sheet molding compound (SMC) manufacturing process or defects in the manufactured molded parts, which lead to a reduction in the mechanical properties (notch reduction effect). Furthermore, due to the inhomogeneous recyclate particles, it is not possible to manufacture molded parts in the Class A range according to prior art. Due to these disadvantages, the circular economy could not yet be implemented in the thermosetting plastics sector.

Based on the aforementioned disadvantages of prior art, the object of the present invention is to provide an improved method for obtaining recyclate from thermosetting starting materials, such as in particular from thermosetting fiber composites, which can be used as a substitution component for a mineral filler in the context of the new production of a plastic, such as in particular a thermoplastic or thermosetting plastic or in particular a fiber composite semi-finished product with a thermosetting or thermoplastic matrix, which can preferably in turn be used as a Class A component.

According to a first aspect, the aforementioned object is achieved by a method for obtaining recyclate from thermosetting starting materials. The method according to the invention comprises the following method steps:
A) providing thermosetting starting materials to be recycled;
B) breaking the thermosetting starting materials of method step A) with a twin-shaft shredder to obtain a plurality of fragments;
C) shredding the fragments of method step B) with a single-shaft shredder to obtain a plurality of flakes; and
D) fine grinding of the flakes of method step C) with a grinding device to obtain a recyclate powder.

It is particularly preferable for thermosetting fiber composite components to be provided as the thermosetting starting material to be recycled in method step A).

In particular, the fiber composite parts can be molded fiber composite parts. The fiber composite components preferably comprise glass fibers embedded in a cured thermosetting matrix material. The sources of the thermosetting fiber composite components to be recycled can come from different areas, for example SMC molded parts from boat and ship building, rotor blades from wind turbines or further fiber composite molded parts can serve as a starting material, which are now to be recycled.

In the context of the present invention, the term “starting materials to be recycled” should thus be understood to mean any materials, material mixtures or also components which comprise at least one thermosetting plastic and preferably reinforcing fibers, such as particularly preferably glass fibers, which are embedded in a thermosetting plastic. The starting materials to be recycled are, for example, waste products that accumulate as surplus cuttings/excess sections etc. during the production of new parts, such as fiber composite components. However, old fiber composite components or thermosetting components which can no longer be used for their intended function due to aging or destruction and which would therefore actually have to be disposed of and can now be used sustainably in the method according to the invention to obtain recyclate as a starting material for manufacturing new thermosetting components can also be used in the present method.

The flakes can be a small thin object, which can be brittle, but can also have a certain ductility.

It may be provided that the thermosetting starting materials, such as in particular the fiber composite molded parts in method step B), are broken to fragments having an average edge length in the range from 5 cm to 20 cm.

Furthermore, it can be preferably provided that in method step C), the fragments are shredded into flakes with an average edge length in the range of 1 to 5 cm, particularly preferably 2.5 cm.

It may be provided to shred the fragments in method step C) using a cutting mill, a single-shaft shredder and/or a hammer mill. According to the invention, a combination of the aforementioned devices can also be used for shredding.

In method step D), the flakes can be finely ground into the recyclate powder using an impact jet mill and/or a ball mill. The flakes can be finely ground into the recyclate powder at a throughput in the range of 100 kg/h to 1000 kg/h using the impact jet mill or the ball mill.

In particular, it may be provided that the flakes are finely ground using a cryogenic cooling screw with continuous addition of nitrogen. The use of a cryogenic cooling screw with continuous addition of nitrogen is particularly advantageous if ductile flakes are to be finely ground.

It may be provided that the flakes are finely ground to an average grain size/particle size of less than 100 μm in method step D).

In particular, it may be provided that in method step A), thermosetting fiber composite components as sheet molding compound (SMC) parts are provided as thermosetting starting materials.

It can be particularly advantageous to provide a further method step A0) before method step A), wherein uncured or incompletely cured fiber composite semi-finished products are provided and the uncured fiber composite semi-finished products are then cured to obtain fiber composite parts to be recycled as thermosetting starting materials for method step A).

It may be provided that in method step A0), the uncured fiber composite semi-finished products are positioned flat under an electromagnetic radiation source and exposed to electromagnetic radiation in the wavelength range from 780 nm to 1 mm to heat the fiber composite semi-finished products, preferably to a surface temperature in the range from 150°° C. to 250° C.

The cured SMC material can then be shredded and finely ground in the same way as the cross-linked thermosetting molded parts or thermosetting starting materials. The aforementioned procedure has the advantage that a costly and CO₂-intensive disposal of the non-crosslinked thermosetting materials is no longer necessary and the cured thermosetting molded parts can in turn be recycled.

Alternatively, it may be provided that in method step A0), the uncured fiber composite semi-finished products are introduced into a tempering furnace and subjected to a temperature in the range from 80° C. to 200° C. in the tempering furnace, and the fiber composite semi-finished products are cured in the tempering furnace for a period of time in the range from 15 to 360 minutes.

The cured SMC materials can then be shredded and finely ground in the same way as the cross-linked thermosetting fiber composite molded parts or the thermosetting starting materials, which in turn avoids the complex, costly and CO₂-intensive disposal of the uncured SMC materials and allows them to be recycled as a filler substitute.

According to a second aspect, the present invention relates to a manufacturing method for a thermosetting fiber composite semi-finished produced, comprising the following method steps:
A) providing the formulation ingredients for manufacturing a thermosetting matrix material for fiber composite semi-finished products comprising a filler mixture and a thermosetting reactive resin, wherein the filler mixture comprises at least recycled powder from recycled thermosetting starting materials, such as in particular fiber composite materials, preferably obtained by a method according to the first aspect of the invention in a weight ratio of 1% to 40% of the total weight of the filler mixture;
B) conveying the formulation ingredients of step A) comprising the filler mixture and the reactive resin into a dissolver with the aid of at least one metering device;
C) mixing the formulation ingredients using a dissolver disk and/or a double suction toothed disk in the dissolver process to obtain a homogeneous resin-filler mixture comprising the recyclate powder;
D) doctor blade coating of the resin-filler mixture of step C) onto a co-extruded drag film, wherein the resin-filler mixture is added to the drag film via a doctor blade box;
E) applying chopped fibers, fiber fabrics, non-crimp fabrics made of glass fiber or alternative fiber types such as carbon fibers or natural fibers to the resin-filler mixture coated with a doctor blade onto the drag film to obtain a fiber-resin-filler semi-finished product; and
F) fulling the fiber-resin-filler semi-finished product to obtain a semi-finished product, wherein the fibers are uniformly enclosed with the reactive resin and the recyclate powder.

The addition of recyclate can increase the mechanical properties of the matrix. This in turn makes it possible to increase the mechanical properties of the manufactured fiber composite molded parts, which means that the amount of glass fibers added can be reduced.

In addition to the recyclate powder, the filler mixture in method step A) may also contain the following other formulation ingredients: unsaturated polyester (UP) resins, vinyl ester (VE) resins, unsaturated hybrid resins, styrene, vinyl toluene, thermoplastic solutions, calcium carbonate as a filler, as well as peroxides, inhibitors, wetting and dispersing additives and pigments.

According to a third aspect, the present invention relates to a manufacturing method for a Class A fiber composite molded part comprising the method steps according to the second aspect of the present invention and further comprising the following method steps:
G) pressing the semi-finished product of step F) to obtain a fiber composite molded part;
H) applying an in-mold coating layer in the pressing process with subsequent or direct painting; and
I) curing the fiber composite molded part.

According to a fourth aspect, the present invention relates to the use of a recyclate powder obtained by a method according to the first aspect of the present invention as a filler for manufacturing a thermosetting or a thermoplastic fiber composite semi-finished product, in particular for manufacturing a Class A fiber composite component.

According to a further aspect, the present invention relates to the use of a recyclate powder obtained by a method according to the first aspect of the present invention as an alternative filler for the plastics industry and in further sectors.

Alternatively, the recyclate powder can be used in other sectors as a substitute for mineral fillers, for example the recyclate powder can be used in the thermoplastics sector (extrusion, injection molding or thermoforming sector).

By using the recyclate powder according to the invention in the field of manufacturing plastics, a reduction in the CO₂ balance can be achieved by adding the recyclate obtained with regard to the substitution of mineral fillers and the elimination of the disposal of the recycled thermosetting plastics or fiber composites. The invention thus advantageously enables a reduction of natural resources (mineral fillers) through the use of the recyclate obtained. Furthermore, the recyclate does not require any crosslinking aids when used with reactive resin systems such as UP resins.

1. A method for obtaining recyclate from thermosetting materials, comprising the following method steps:
A) providing thermosetting starting materials to be recycled;
B) breaking the thermosetting starting materials of method step A) with a twin-shaft shredder to obtain a plurality of fragments;
C) shredding the fragments of method step B) with a single-shaft shredder to obtain a plurality of flakes; and
D) fine grinding of the flakes of method step C) with a grinding device to obtain a recyclate powder.

2. The method according to claim 1, wherein thermosetting fiber composite components are provided as a thermosetting starting material to be recycled in method step A).

3. The method according to claim 1 wherein in method step B), the thermosetting starting materials are broken to fragments having an edge length in the range from 5 cm to 20 cm.

4. The method according to claim 1, wherein in method step C), the fragments are shredded into flakes having an edge length in the range from 1 cm to 5 cm.

5. The method according to claim 1, wherein the fragments are shredded in method step C) using a cutting mill, a single-shaft shredder and/or a hammer mill.

6. The method according to claim 1, wherein in method step D), the flakes are finely ground into the recyclate powder using an impact jet mill and/or a ball mill.

7. The method according to claim 6, wherein the flakes are finely ground into the recyclate powder at a throughput in the range of 100 kg/h to 1,000 kg/h using the impact jet mill and/or the ball mill.

8. The method according to claim 6, wherein the flakes are finely ground using a cryogenic cooling screw with continuous addition of nitrogen.

9. The method according to claim 1, wherein in method step D), the flakes are finely ground to a grain size in the range of less than 100 μm.

10. The method according to claim 1, wherein in method step A), thermosetting fiber composite parts as sheet molding compound (SMC) parts are provided as thermosetting starting materials.

11. The method according to claim 1, wherein the method before method step A) comprises the following additional method step:
A0) providing uncured or incompletely cured fiber composite semi-finished products and curing the uncured fiber composite semi-finished products to obtain fiber composite parts to be recycled for use as thermosetting starting materials for method step A).

12. The method according to claim 11, wherein in method step A0), the uncured fiber composite semi-finished products are positioned flat under an electromagnetic radiation source and exposed to electromagnetic radiation in the wavelength range from 780 nm to 1 mm to heat the fiber composite semi-finished products.

13. The method according to claim 11, wherein the fiber composite semi-finished products are heated to a surface temperature in the range from 150° C. to 250°° C.

14. The method according to claim 11, wherein in method step A0), the uncured fiber composite semi-finished products are introduced into a tempering furnace, and a temperature in the range from 80° C. to 200° C. is generated in the tempering furnace, and the fiber composite semi-finished products are cured in the tempering furnace for a period of 15-360 minutes.

15. A manufacturing method for a thermosetting fiber composite semi-finished product, comprising the following method steps:
A) providing the formulation ingredients for manufacturing a thermosetting matrix material for fiber composite semi-finished products comprising a filler mixture and a thermosetting reactive resin, wherein the filler mixture comprises at least recycled powder from recycled thermosetting starting materials, such as in particular fiber composite materials, obtained by a method according to claim 1 in a weight ratio of 1% to 40% of the filler weight;
B) conveying the formulation ingredients of step A) comprising the filler mixture and the reactive resin into a dissolver with the aid of at least one metering device;
C) mixing the formulation ingredients using a dissolver disk and/or a double suction toothed disk in the dissolver process to obtain a homogeneous resin-filler mixture including the added recyclate;
D) doctor blade coating of the resin-filler mixture of step C) onto a co-extruded drag film, wherein the resin-filler mixture is added to the drag film via a doctor blade box;
E) applying chopped fibers, fiber fabrics, non-crimp fabrics made of glass fiber or alternative fiber types such as carbon fibers or natural fibers to the resin-filler mixture coated with a doctor blade to obtain a fiber-resin-filler semi-finished product; and
F) fulling the fiber-resin-filler semi-finished product to obtain a semi-finished product, wherein the fibers are uniformly enclosed with the reactive resin and the recyclate powder.

16. A manufacturing method for a Class A fiber composite molded part comprising the method steps according to claim 15 and further comprising:
G) pressing the semi-finished product of step F) to obtain a fiber composite molded part;
H) applying an in-mold coating layer in the pressing process with subsequent painting; and
I) curing the fiber composite molded part.
